(19) United States
(12) Patent Application Publication
(10) Pub. No.: US 2003/0093168 A1
(43) Pub. Date: May 15, 2003

(54) System and method for providing game ranking service

(75) Inventor: Yasuhito Nagaoka, Kanagawa (JP)

Correspondence Address: LEYDIG VOIT & MAYER, LTD, 700 THIRTEENTH ST. NW, SUITE 300, WASHINGTON, DC, 20005-3960, US

(73) Assignee: Namco Ltd., Tokyo (JP)

(21) Appl. No.: 10/289,221

(22) Filed: Nov. 7, 2002

(30) Foreign Application Priority Data
Nov. 8, 2001 (JP) 2001-342749

(51) Int. Cl. A63F 13/00

(52) U.S. Cl. 700/91; 463/42; 463/9

(57) ABSTRACT

A computer system (a ranking server) provides a ranking service to players of a computer-controlled game. The server accepts an entry procedure from a mobile terminal or a personal computer. Then, the server classifies players who made entries into groups according to players' levels which is decided based on the play results of the player stored in a storage medium. The server assigns game tasks (character, stage, etc.) for each group or each player, and sends information about the task to each player by e-mail. Each player sets the assigned task to his/her game machine and plays the game. After the play, the player uploads the play record to the server by using a mobile phone or a personal computer. The server collects the records and sorts the records for each group to determine ranking for each group. The server sends the ranking information for each group to the players by e-mail.

### BACKGROUND OF THE INVENTION

1. Field of the Invention

The present invention proposes a new system and method for providing ranking service such as Internet Ranking service for computer-controlled games.

2. Background Art

An arcade game machine placed in amusement arcades usually has a function of displaying score ranking of players. A player who made a high score in a game can get his/her name listed in the ranking list by entering his/her name into the game machine after the game is over. There are also many video games for home game machines or for personal computers that have similar functions so that the players can store their own scores.

Such functions have developed into a service called “Internet Ranking”. Game providers (or sometimes individuals) provide the Internet Ranking service on the Internet by a server computer in which ranking determination programs are installed. After playing a game using an arcade game machine or a home game machine, a player accesses the server using a mobile terminal or a personal computer to register his/her score of the game. The server sorts scores that are registered by players for each game, and gives ranking information to the players. The server enables players to compete with one another for scores even when the players play a game at different place, different times, or using different machines. When a predetermined period is defined during which players are allowed to register his/her scores, a competition on the Internet can be realized.

The Internet Ranking service is an attractive service for advanced players who are always longing for competitors, since Internet Ranking service enables players to compete with other players in any state in the United States and in any country in the world. On the other hand, for beginners whose names would hardly appear in the ranking list unless the number of players is quite small, it is hardly worth using the Internet Ranking service, especially when many powerful players access the server.

### SUMMARY OF THE INVENTION

The Internet Ranking service, though including a problem for beginners mentioned above, is in fact effective for preventing the players from getting tired of playing, since ranking announcement agitates their competitive spirit and encourages them to continue to play. Therefore, the present invention proposes a new Internet Ranking service that will enable all levels of players to enjoy a competition on the Internet.

According to one aspect of the present invention, the present invention provides a computer system (hereinafter called a “ranking server”) for providing a ranking service to players of a computer-controlled game. According to other aspect of the present invention, the present invention provides a computerized method for providing a ranking service to players of a computer-controlled game. According to still other aspect of the present invention, the present invention provides a computer-readable medium on which is stored program modules for providing a ranking service to players of a computer-controlled game, or a computer data signal embodied in a carrier wave and representing sequences of instructions for providing such a ranking service.

The method, which is performed by the computer system of the present invention, and which is defined by the program module stored on the medium of the present invention, comprises the following steps. First the system receives an entry data indicating an entry of a player to the ranking service from the player. Then the system decides a level of the player whose entry has been accepted in the entry receiving step. Next, the system classifies the players whose entries have been accepted into one or more groups based on players' levels respectively decided in the level deciding step. Then, the system assigns tasks to players in each group to which one or more players are assigned in the classifying step. After the classification, the system generates control data for each player that indicates the group to which the player belongs and the game task assigned to the player. The control data is to be used by the computer (player's game machine) to control the game. The system collects result data indicating play results of the games that is controlled by using the control data generated in the data generating step. Finally, the system decides players' ranking based on the play results collected in the result collecting step, for the each group to which one or more players are assigned in the classifying step respectively.

Other and further objects, features and advantages of the invention will appear more fully from the following description.

### BRIEF DESCRIPTION OF THE DRAWINGS

The present invention will be more apparent from the following detailed description, when taken in conjunction with the accompanying drawings, in which;

FIG. 1 illustrates an overview of services provided by a ranking server according to one embodiment of the present invention;

FIG. 2A illustrates a hardware configuration of the ranking server necessary to provide the services in FIG. 1;

FIG. 2B illustrates a hardware configuration of a mobile phone in FIG. 1;

FIG. 2B illustrates a hardware configuration of a home game machine in FIG. 1;

FIG. 3 illustrates a transition of contents displayed on a screen of the home game machine;

FIGS. 4A and 4B illustrate screen images of Network Service Menu;

FIGS. 5A to 5C illustrate screen images of “Best Record Display” screen;

FIG. 6 illustrates a transition of contents displayed on a screen of the mobile terminal;

FIGS. 7A to 7D illustrate screen images of Best-Record-Registration screen;

FIG. 8 is a flow chart showing Best-Record-Registration process;

FIGS. 9A to 9D illustrate screen images related to a competition entry procedure;

FIG. 10 is a flow chart showing player classifying and task setting process;

FIG. 11 illustrates screen image displaying an e-mail that notifies Competition-Play-Password to a player;

FIGS. 12A to 12C illustrate screen images of Competition Password-Enter screen;

FIGS. 13A to 13C illustrate screen images related to competition play;

FIG. 14 is a flow chart showing Competition-Play process;

FIGS. 15A to 15D illustrate screen images related to Competition-Record-Registration procedure;

FIG. 16A is a flow chart showing Competition-record Collection process;

FIG. 16B is a flow chart showing Sorting and Ranking decision process; and

FIG. 17 illustrates screen image displaying an e-mail including ranking list.

### DETAILED DESCRIPTION OF THE PREFERRED EMBODIMENTS

Preferred embodiments of the present invention will be hereinafter described with reference to the accompanying drawings.

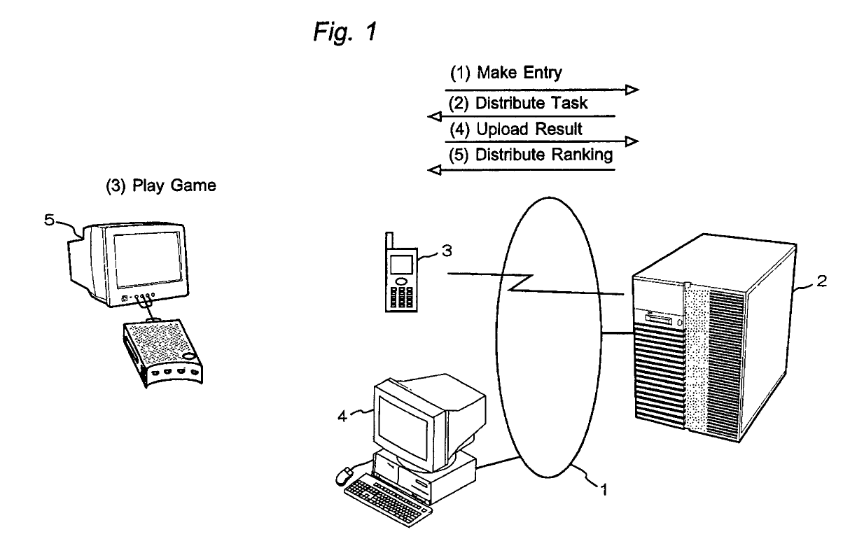

First, an overview of services provided by a ranking server of this embodiment will be explained with reference to FIG. 1. A service provider such as a game provider provides a service using one or a plurality of computers (server 2) connected to a network 1 such as Internet. Users of this service use the service by accessing the server 2 using a mobile terminal such as a mobile phone 3 or a personal digital assistant (PDA), or using a personal computer 4 accessible to the network 1.

The ranking server provides a matching service of players who are almost equal in ability with respect to a certain game, a competition holding service, and a ranking determining service of the players who participate in the competition. A player who intends to participate in the competition accesses the server 2 using the mobile phone 3, and makes entry to the competition. The server 2 classifies the players who made entries into groups according to players' levels. Next, the server 2 sets game tasks for each group (e.g., characters and stages, etc.) and distributes information about the set game tasks to the players by e-mail. The player who has received by the mobile phone 3 the e-mail including information about the set game tasks then enters the information into the game machine 5 which is not connected to the network 1. Then, the player starts to play a game using the game machine 5. After the game is over, the player accesses the server 2 using the mobile phone 3 again to upload his/her game records (play result). The server sorts the records of a plurality of players, determines the ranking for each group and distributes the ranking list by e-mail.

Next, means for realizing this service will be explained. A specific program installed in the server 2 realize this service, though those skilled in the art will be aware that a part of program (program modules or image data) may be downloaded to the mobile terminals or personal computers when players access the server 2 and may be executed on them. Before explaining the process defined by the program, hardware and other configurations as prerequisites will be explained.

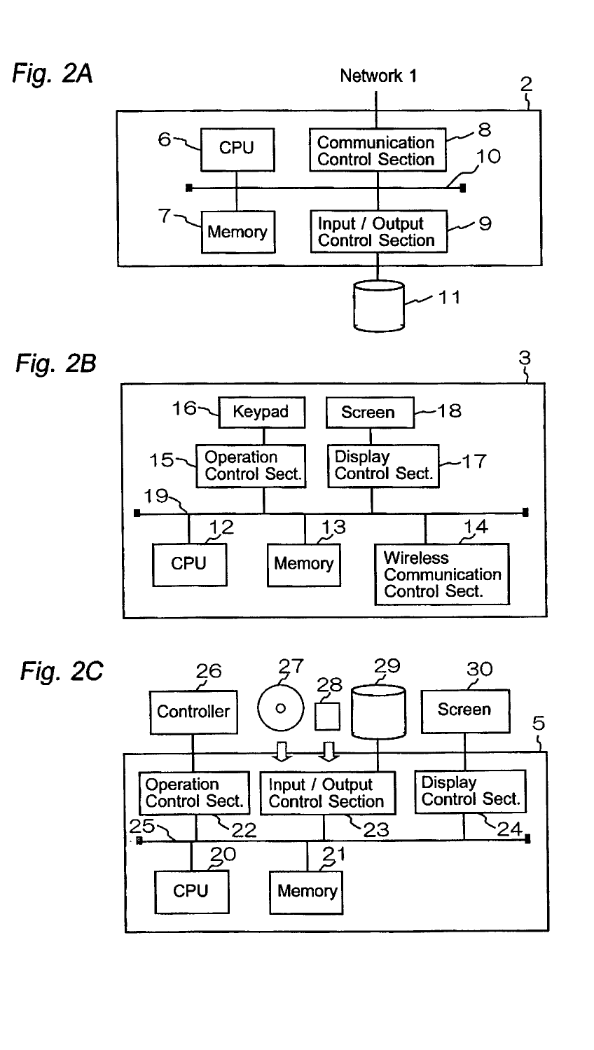

FIGS. 2A, 2B and 2C illustrate hardware configurations of the server 2, the mobile phone 3 and the game machine 5, respectively. As shown in FIG. 2A, the server 2 is provided with at least a CPU 6, a memory 7, a communication control section 8, an input/output control section 9 and a system bus 10 that connects those sections. The communication control section 8 is connected to the network 1 and controls a communication with the mobile phone 3 or the personal computer 4 or communications with other computers (not shown). Furthermore, a hard disk 11 is connected to the input/output control section 9. The programs are stored in the hard disk 11 or other memory, loaded to the memory 7 when the system is started, and executed by the CPU 6.

As shown in FIG. 2B, the mobile phone 3 is provided with at least a CPU 12, a memory 13, a wireless communication control section 14, an operation control section 15, a display control section 17 and a system bus 19 that connects these sections. A wireless communication control section 14 is, for example, a high frequency radio communication control section including an antenna. An operation control section 15 controls operation signals input from a keypad 16. A display control section 17 controls output data representing characters and images, etc. to a screen 18. The mobile phone 3 is provided with functions of downloading various screen images, which will be described later, from the server 2. The mobile phone 3 is also provided with functions of displaying the images on the screen 18 and sending information input from the keypad 16 to the server 2. These functions are publicly known as functions of a mobile terminal.

Furthermore, the game machine 5 is provided with at least a CPU 20, a memory 21, an operation control section 22, an input/output control section 23, a display control section 24 and a system bus 25 that connects these sections. The operation control section 22 controls operation signals input from a game controller 26. A competition-play-password, which will be described later, is input using this game controller 26. The input/output control section 23 controls data reading from a recording medium such as a CD-ROM or DVD 27, a memory card 28 and a hard disk 29 and data writing to those recording media. The display control section 24 controls displays on a screen 30 of an image output from a game control program.

The above described hardware configuration is only a minimum configuration necessary to implement the present invention and it is apparent to those skilled in the art that the object of the present invention can be attained with other similar configurations. For example, the mobile phone 3 is only an example of a terminal to receive services provided by the server 2 and it goes without saying that the present invention is applicable to the aforementioned personal computer 4, portable information processing terminals such as a PDA or portable game machines as well.

Focusing on contents displayed on the screen 18 of the mobile phone 3 and screen 30 of the game machine 5, services provided by the server of this embodiment will be explained in detail below.

In this embodiment, the server 2 provides the ranking service for a video game in which the player controls the movement of a character in a virtual space. The character controlled by the player destroys blocks piled in the virtual space using a drill and digs his/her way while moving from top down or right and left if necessary. The game defines a plurality of characters that have different characteristics and capabilities. The degree of difficulty of the game changes depending on the character used to play the game. Furthermore, there are two types of game events; an event competing for the depth dug during a predetermined time (called “Mission Driller”) and an event competing for the time required to dig a predetermined depth (called “Time Attack Driller”). A plurality of stages that have different space layouts (block arrangement, etc.) are defined, and one of them is selected for each competition. The degree of difficulty of the game also changes with the type of event or stage. Scores are added according to not only the dug depth or the required time, but also other elements. The ranking is determined based on the depth, the time and the score acquired.

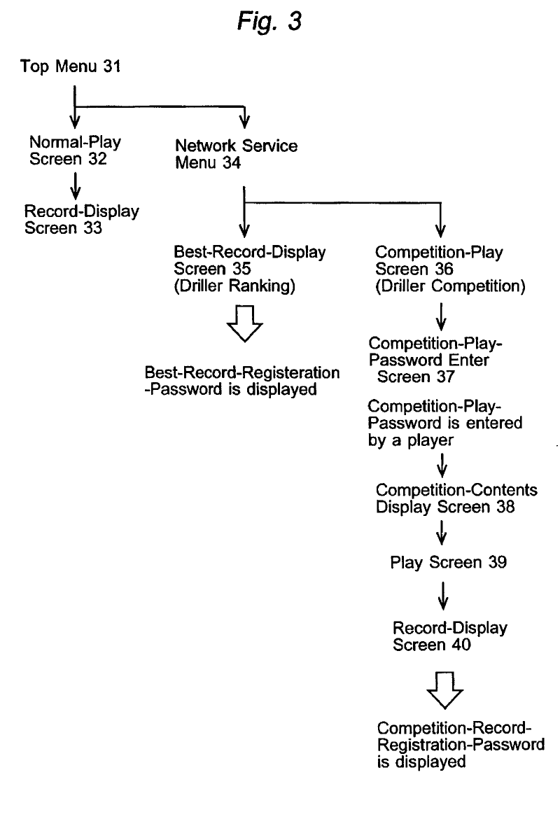

The program to control the game is provided as game program product for the game machine 5. FIG. 3 is a diagram showing a transition of contents displayed on a screen of the game machine 5 by this game control program. The player selects either to play a normal game or to participate in a competition with other players using a network service on a Top menu 31.

When the player selects to play a normal game, the player may select a character, event-type, stage, etc. on a subsequently displayed Normal-Play screen 32, and starts to play the game. When the play is completed, a play record including the depth that has been dug or the time required for digging and acquired score are displayed on a Record-Display screen 33. The record displayed here is saved in the memory card 28 set in the game machine 5.

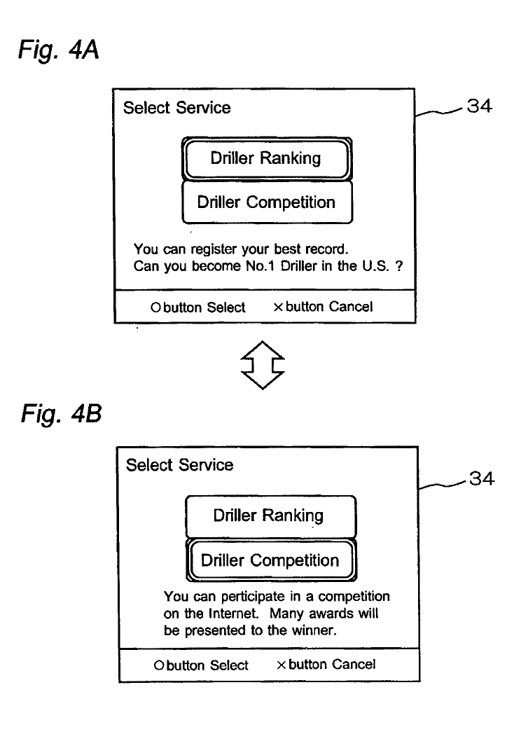

On the other hand, when the player selects to use a network service, the player is requested on a Network Service Menu screen 34 to select either a Best-Record-Display service (“Driller Ranking”) or a Competition-Play service (“Driller Competition”). FIGS. 4A and 4B show screen images of the Network Service Menu 34. FIG. 4A shows the case where the “Driller Ranking” service is selected and FIG. 4B shows the case where the “Driller Competition” service is selected.

When the “Driller Ranking” service is selected, the best record which is obtained by sorting the results saved in the memory card 28, and a Best-Record-Registration-Password that is needed to register the best record to the server 2 are displayed on the Best-Record-Display screen 35. The best record is displayed for each stage (space layout) of each event-type. The best record in this embodiment means such a record including the deepest depth or the shortest time. However, when there are two or more record including the same depth or the same time, the record including the highest score among them is determined to be the best record.

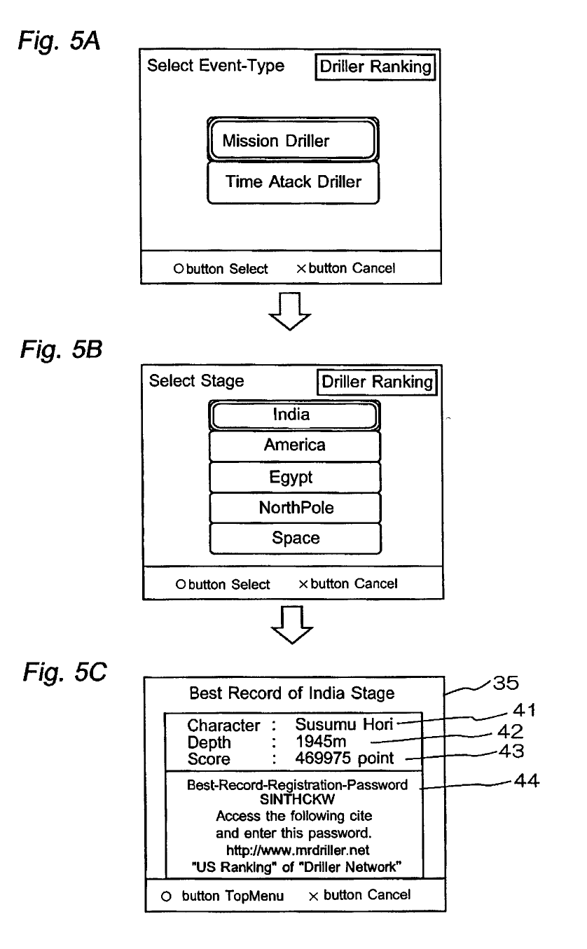

When the player sets the cursor on the “Driller Ranking” as shown in FIG. 4A and presses the O button of the controller 26 to select the service, the event menu shown in FIG. 5A appears. When the player selects one event, then the stage menu (space layout menu) shown in FIG. 5B appears. FIG. 5A and FIG. 5B show cases where the player selects the “Mission Driller” as the event and selects an “India” stage from among five stages as the space layout. In this case, as shown in FIG. 5C, a character 41, dug depth 42 and score 43 are represented as the best record of the player in the “India” stage.

Furthermore, the Best-Record-Display screen 35 also displays a Best-Record-Registration-Password 44. The player may register the best record to the server 2 by entering the Best-Record-Registration-Password 44 on a predetermined screen of the mobile phone 3. The Best-Record-Registration-Password 44 is an eight alphabetical character code, which is generated by encoding data of the event-type, the stage, the character 41, the depth 42 and the score 43 based on predetermined coding rules.

Next, the procedure for a registration of the best record obtained as described above to the server 2 and the process executed on the server for that purpose will be explained:

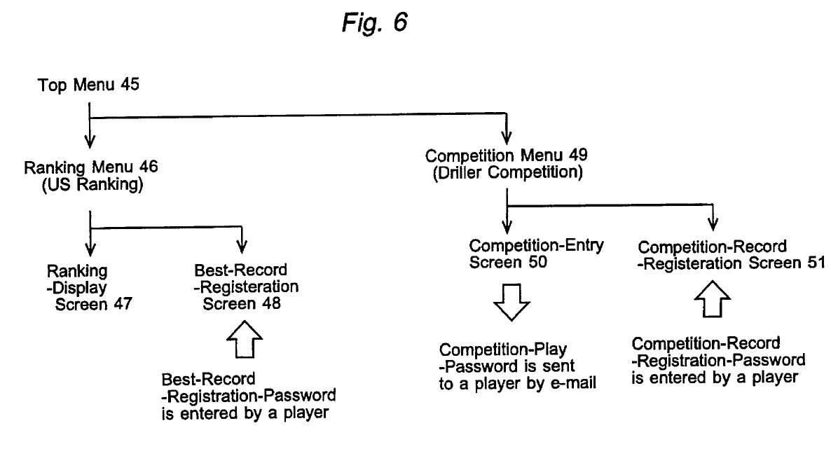

FIG. 6 illustrates a transition of contents displayed on a screen 18 of the mobile phone 3. The server 2 provides these contents. It is necessary, to use the service provided by the server 2, to get registered as a user on a user registration screen (not shown) and acquire a user ID or user authentication password beforehand. After user registration is completed, the user can use the service by entering the user ID and user authentication password on a predetermined login screen.

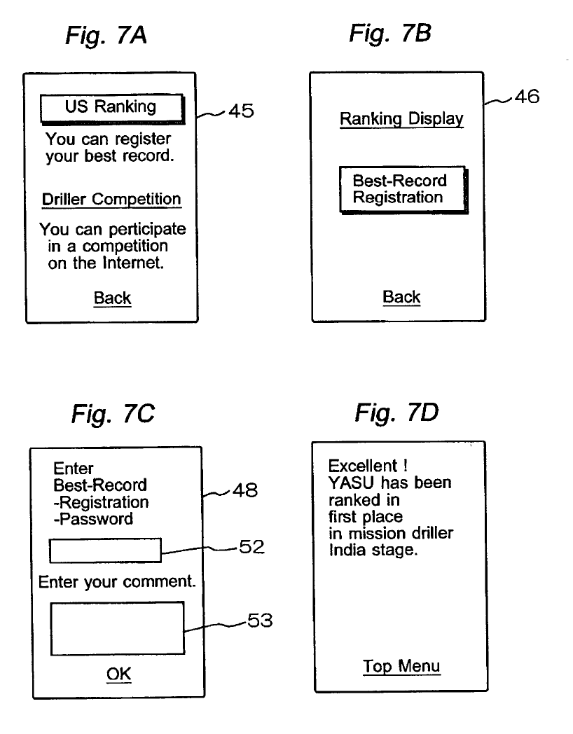

After login, the user can select from a top menu 45 which appears first, either a Ranking Menu 46 (US Ranking) that provides a ranking management service or a Competition Menu 49 (Driller Competition) that provides a competition service. FIG. 7A shows a screen image of the top menu 45 where the “US Ranking” is selected. When the “US Ranking” is selected, the user is further requested to select either a Ranking-Display screen 47 or a Best-Record-Registration screen 48. FIG. 7B is a screen image of the Ranking Menu 46 where the Best-Record-Registration screen 48 is selected.

The Ranking-Display screen 47 shows the best record in the ranking registered by players in literally all area in the U.S.A. The Best-Record-Registration screen 48 requires the user to enter the best record and the Best-Record-Registration-Password displayed on the Best-Record-Display screen 35 in FIG. 3. FIG. 7C shows a screen image of the Best-Record-Registration screen 48. As shown in the drawing, this embodiment allows not only the Best-Record-Registration-Password 52 but also player's comment 53 to be entered. The comment 53 entered here is announced together with the ranking list.

Furthermore, according to this embodiment, immediately after the player registers the best record on the Best-Record-Registration screen 48, the server 2 performs sorting of the best records and determines the rank of the player. According to the rank, a message, for example a message as shown in FIG. 7D, is displayed. This message is created by embedding the name of the player in a predetermined section of a standard message defined for each rank.

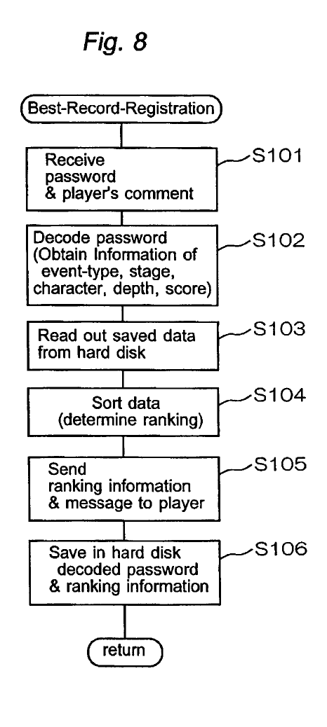

FIG. 8 is a flow chart showing Best-Record-Registration process performed by the aforementioned server 2. As shown in FIG. 8, when the player enters the Best-Record-Registration-Password 52 and the comment 53 on the Best-Record-Registration screen 48, the server 2 receives them in step S101 and decodes the received password in next step S102. If a wrong password is received in the step S101, an error message (not shown) may be output in the step S102 since the password includes a redundant code for error detection in addition to information such as scores.

As a result of decoding of the password, if information such as the event, stage, character, depth, scores can be obtained, then in step S103, data of the best records of other players already saved in the hard disk 11 are read out from the hard disk 11. The best records are sorted to determine ranking in step S104. Furthermore in step S105, a message that corresponds to the determined ranking is selected from among a plurality of predefined types of messages, the name of the player is inserted in a predetermined message as shown in FIG. 7D and sent to the mobile phone 3. In step S1106, the password decoded in step S102 and the ranking determined in step S105 are saved in the hard disk 11.

Through Best-Record-Registration process, best records of the respective players are stored in the hard disk 11 of the server 2.

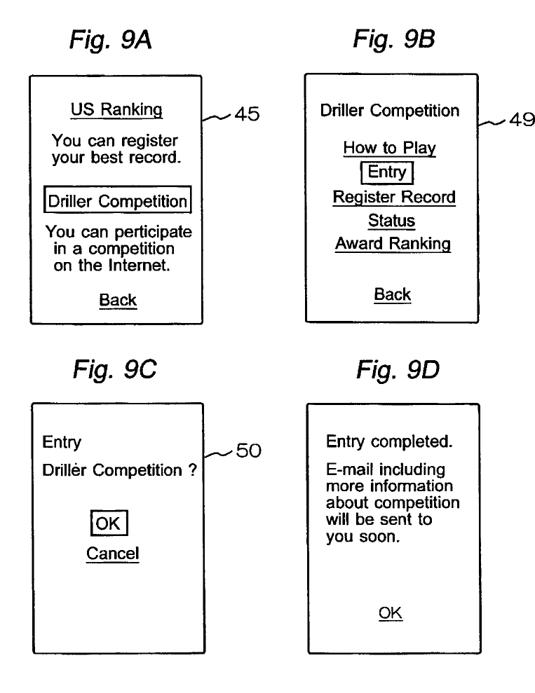

Returning to FIG. 6, the procedure for participating in a competition and the process performed by the server 2 will be explained. To carry out a procedure for participating in the competition, a Competition Menu 49 should be selected on the top menu 45 shown in FIG. 6, as shown in FIG. 9A. FIG. 9B illustrates a screen image of the Competition Menu 49. The Competition Menu 49 lists five menu items, “How to play”, “Entry”, “Register Record”, “Status”, and “Award Ranking”. Selecting “How to play” shows an explanation as to how the game is played. “Entry” and “Register record” will be described later. Selecting “Status” shows the level and other statuses of the player. Selecting “Award ranking” shows the ranking of the sum total of awards acquired so far.

When “Entry” is selected on the Competition Menu 49, the screen image shown in FIG. 9C appears to confirm the intention of the entry and if “OK” is selected, the screen image shown in FIG. 9D appears to notify the completion of the entry. The server 2 stores, in the memory 7 or hard disk 11, the user ID, etc. of the player who went through procedure for the entry.

It is necessary to set a deadline for the entry to hold a competition. This embodiment sets a time limit and accepts only those players who have completed entry procedures by the time limit. For example, suppose an entry period for a first competition is set to 17:00 to 17:10 and an entry period for a second competition is set to 17:10 to 17:20, and entries will be accepted at intervals of 10 minutes thereafter. This causes a wait time for each player to be 10 minutes at most. Periods can be segmented according to an increase/decrease in the number of participants in the competition as appropriate. If the number of applicants is small, it is possible to secure a certain number of applicants by setting a longer time limit, for example, for every 30 minutes. As the method of setting a time limit for entries, the number of people who can participate in the competition is determined first, and then entries are accepted on a first-come-first-served basis and entries may be closed at a time at which the number of players who made entries reaches the number described above.

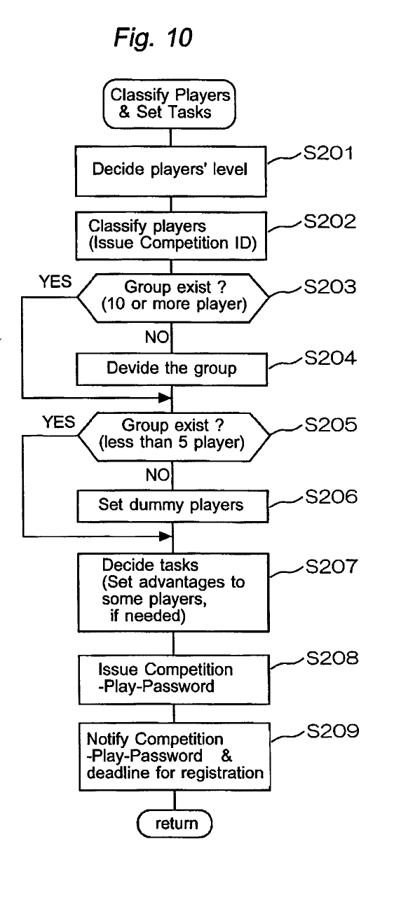

When one period has elapsed or when the number of people who made entries reaches the predetermined number, the server 2 closes entries and then classifies and divides players into groups and sets tasks to be assigned to the players of the respective groups. FIG. 10 is a flow chart showing the grouping and task setting process. First, in step S201, the level of each player who made an entry is decided. The method of deciding levels will be described later.

Then, in step S202, players are classified based on the levels decided in step S201. The maximum value of levels is 20 and minimum value is 1 in the game of this embodiment. Then, the players are classified into four groups of level 1 to 5, 6 to 10, 11 to 15 and 16 to 20. For example, suppose there are 10 players and their levels are 1, 2, 5, 5, 6, 8, 9, 16, 19 and 20. Then, a total of three groups are formed; a group of four players whose levels are 1, 2, 5 and 5, a group of three players whose levels are 6, 8 and 9 and a group of three players whose levels are 16, 19 and 20. As shown in this example, players are not necessarily divided into all the four groups and there can be cases where there are groups with no players. A competition will be held in groups to which one or more players belong and a competition ID will be issued to identify each group. The server 2 identifies each group using this competition ID and manages players who belong to the group and the deadline for a registration of the competition result, etc. in association with the competition ID.

Furthermore, the number of players of one group is three or four in the above example, but if the server 2 decides in step S203 that there are groups with ten or more players, the server 2 further divides the group in step S204 so that the number of players of one group becomes ten or less than ten. For example, in the case of eleven players, these players are divided into one group of five and the other group of six.

On the other hand, if it is decided in step S205 that there is (are) a group(s) with fewer than five players, a dummy player(s) is (are) set in step S206 so that the number of players of one group is always five or more. In the above described case, the numbers of players of all groups are smaller than 5 and therefore dummy players are added. The level of a dummy player is set to a level equivalent to the level of each group. In the case of the first group whose players have levels 1, 2, 5 and 5, a dummy player, for example, of level 4 is added so that the number of players of the group becomes 5. The play result of the dummy player is calculated by using a predetermined function related with the set level and random number elements. For example, suppose the level of a player who digs approximately 400 m on average is 4. Then, the play result of the dummy player of level 4 is determined by using a random number function that generates random values between 350 and 450. Setting a dummy player(s) according to the level of the group can avoid such problems that a competition cannot be held with only one participant, a competition may be held but there are too few participants to enjoy the game or players of different levels are forcibly matched because only a few players participate, etc.

Such criteria as ten players and five players are just examples and the maximum or minimum number of players of one group can be determined according to the type of game, etc. as appropriate.

Then, in step S207, game tasks, that is, characters, stage (space layout), time limit and an allowable number of failures, etc. assigned to the player for playing the game are set for the players who belong to each group. In this embodiment, tasks are set for each group in principle, but if a level difference within a group is too large, a task is set for each player. This can give advantages to some players.

For example, if a combination of a group with players of levels 1 to 5 results in nine players of level 5 and one player of level 1, a character easier to handle (e.g., character moving faster or with special ability) than characters of other players may be set as the character used by the player of level 1. A simpler stage than stages of other players may be set for only that player as a task. This gives advantages to some players, and thereby reduces the problem caused by the relatively large level difference within a group.

Then, in step S208, a Competition-Play-Password is issued for each player. First, data in a predetermined format is created, the data including the competition ID issued in step S202 and the tasks set in step S207. This data is control data used when the game machine 5 controls the game. When this control data is input to the game machine 5, the task of the game is fixed to the task set in step S207 and the player can no longer select characters, etc. freely. In the case where the server 2 and game machine 5 are directly connected via the network 1, this control data may be transferred to the game machine 5 via the network 1. However, since the game machine 5 is not connected to the network 1 in this embodiment, and therefore the player needs to manually enter this control data in the game machine 5. Thus, this control data is converted to a code with an eight alphabetical character code according to a predetermined coding rule. However, it is also possible to use Japanese (or other country's) characters, symbols such as +, *, etc. or combinations thereof. This code is used as a Competition-Play-Password. Encoding the competition ID and the game tasks prevents illegal tampering with the tasks by players and encoding them to a short code reduces an input burden on the player at the time of entering tasks in the game machine 5.

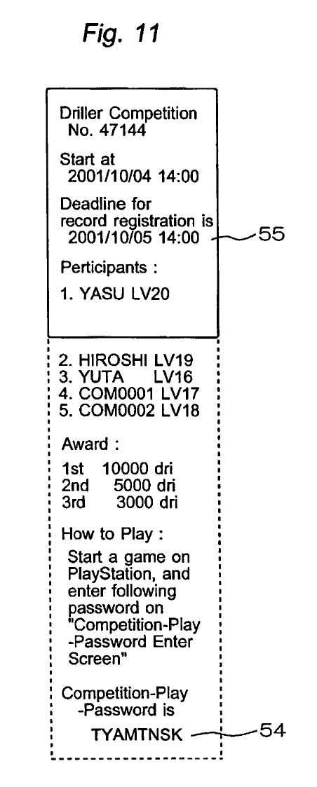

Finally in step S209, e-mail is sent to players to notify their Competition-Play-Passwords and deadline for registration of competition records. FIG. 11 shows an example of e-mail sent to the mobile phone 3 and the area enclosed by dotted line is the area that appears when the screen of the mobile phone is scrolled. The e-mail notifies each competition participant and award when the player wins a prize as shown in the drawing in addition to the Competition-Play-Password 54 and deadline 55. The example in the drawing shows e-mail notifying that a competition will be held with a group of a total of five players with three players who made entries and two dummy players COM0001 and COM0002 who are additionally set. The Competition-Play-Password 54 and deadline 55 can also be notified when the player makes access, e.g., when the player logs in the server 2.

Then, returning to FIG. 3, the process after the entry procedure will be explained.

The player who completed the above procedure plays the game using the game machine 5. To play the game for the competition, the player selects the Competition-Play screen 36 on the network service menu 34 in FIG. 3. On the Competition-Play screen 36, a warning message may be displayed indicating that the player is required to carry out a predetermined entry procedure before performing a competition play, and then the Competition-Play-Password-Enter screen 37 is displayed.

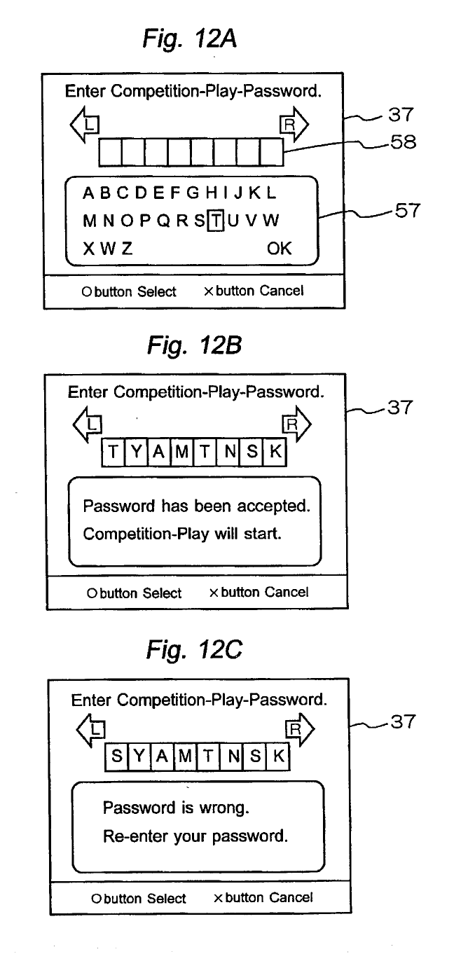

FIGS. 12A, 12B and 12C illustrate the screen image for entering the Competition-Play-Password-Enter screen 37 displayed on the screen 30 of the game machine 5. As shown in FIG. 12A, a table 57 of alphabetical characters that can be selected as an entered character and a password input area 58 are displayed. When the player operates the controller 26, moves the cursor on the screen to any one of alphabetical characters in a table 57 and presses the O button, the selected character is displayed in the password input area 58. FIG. 12B shows a screen image where the eight alphabetical characters has been entered as the Competition-Play-Password.

As described above, the Competition-Play-Password is a coded control data including the competition ID and game tasks. Then, the game control program installed in the game machine 5 decodes the Competition-Play-Password and obtains control data. In the case where the control data resulting from decoding the Competition-Play-Password is inappropriate data that cannot be used for control (e.g., indicating a nonexistent stage, etc.), an error message as shown in FIG. 12C is displayed.

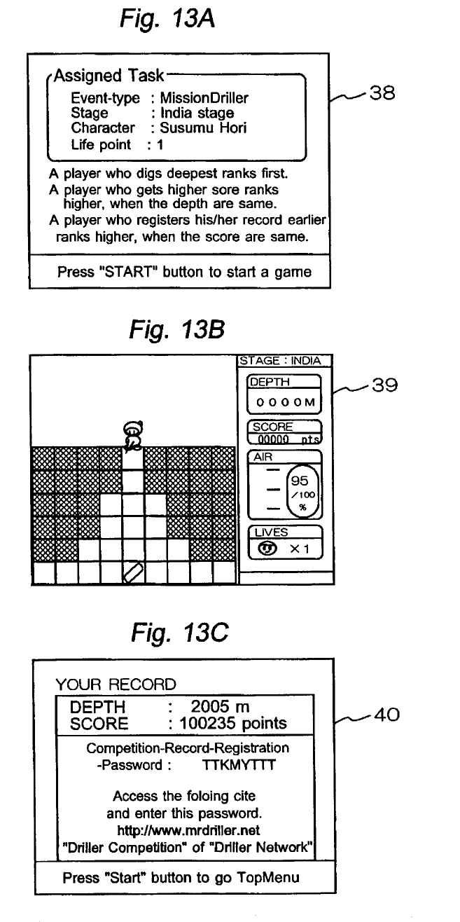

If the Competition-Play-Password is valid, a Competition-Contents-Display screen 38 shown in FIG. 3 appears. FIG. 13A shows a screen image of the Competition-contents-Display screen 38 that displays the assigned tasks; event-type, stage, character used and the number of lives of the character (allowable number of failures) as the contents of the competition. Conditions for a victory are also displayed.

When the player presses the START button of the controller 26 on the Competition-Contents-Display screen 38, a game is started with the task set according to the competition password. FIG. 13B shows a game screen image 39 when the play is in progress and shows how a character is drilling his/her way through piled blocks as described above. The distance (DEPTH) drilled and score (SCORE) are shown on the right of the screen.

When the play is finished, a Record-Display screen 40 appears as shown in FIG. 3. FIG. 13C shows a screen image of the Record-Display screen 40 that displays the depth and score, that is, the competition play result. In this case, the Competition-Record-Registration-Password is also displayed together with the play result. The Competition-Record-Registration-Password is a password generated by coding the competition ID, depth and score into eight alphabetical characters according to a predetermined rule. Unlike the aforementioned Best-Record-Registration-Password, the Competition-Record-Registration-Password includes the competition ID. This is intended to allow the server 2 to arrange the registered play results for each group.

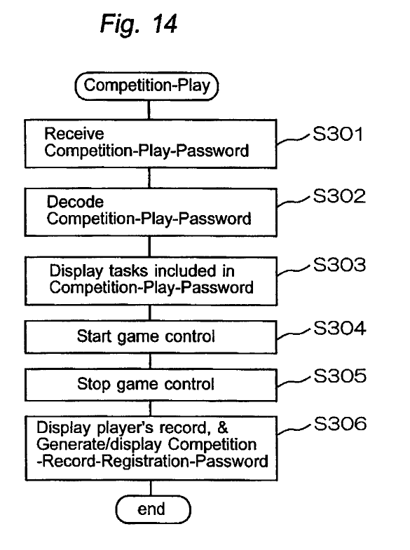

The Competition-Play process described above (that is the process executed by the game machine 5) will be expressed with the flow chart in FIG. 14. A Competition-Play-Password is received in step S301, and the Competition-Play-Password is decoded in step S302 to obtain control data. Then in step S303, the task set by the control data is displayed and control of the game using the control data is started in step S304. In step S305, when the play is finished and game control is finished, the competition record is displayed. Further, a Competition-Record-Registration-Password is generated and displayed in step S306.

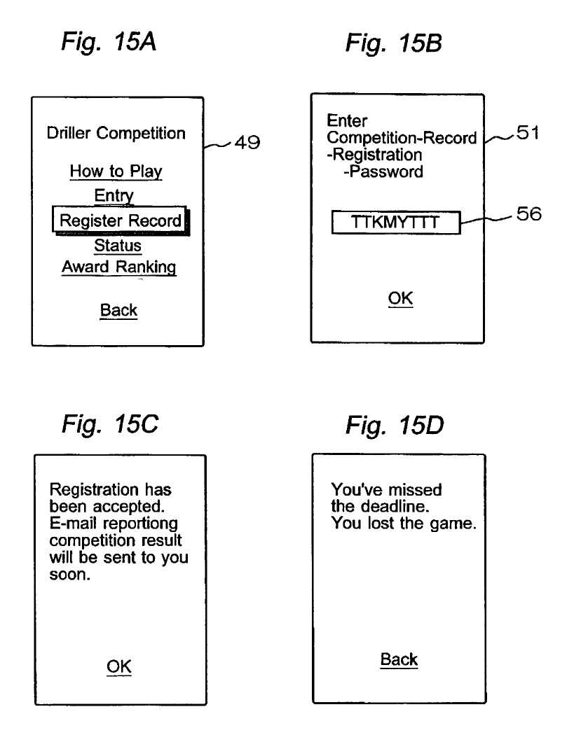

Then, returning to FIG. 6, the procedure for register a competition record to the server 2 using the mobile phone 3 will be explained. A competition record is registered on a Competition-Record-Registration screen 51 that may be selected on the Competition Menu 49. FIG. 15B illustrates a screen image of the Competition-Record-Registration screen 51. As shown in FIG. 15B, the Competition-Record-Registration screen 51 displays a password area 56 and the player enters a Competition-Record-Registration-Password by operating the keypad 16 of the mobile phone 3. When registration is performed before the deadline, a message appears as shown in FIG. 15C indicating that the registration has been accepted. On the other hand, if the registration does not meet the deadline, a message appears as shown in FIG. 15D indicating loss of the game by default.

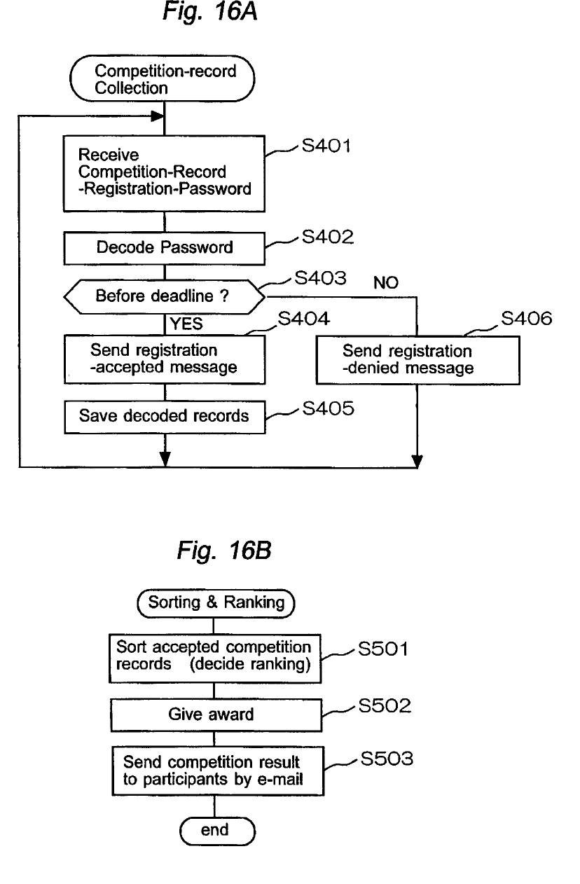

FIG. 16A is a flow chart showing a Competition-Record-Collection process performed by the server 2. In step S401, the server 2 accepts the Competition-Record-Registration-Password sent from the mobile phone 3 and decodes the Competition-Record-Registration-Password in step S402. The Competition-Record-Registration-Password includes the competition ID. On the other hand, the server 2 can recognize players who belong to the group and deadline based on the competition ID. Therefore, the server 2 can judge in step S403 whether the registration meets the deadline or not by associating, using the competition ID, the information included in decoded password with the information stored in the server 2. If the registration meets the deadline, a registration completion message is displayed in step S404 and the competition record is saved in the hard disk 11 of the server 2 in step S405. If the registration has missed the deadline, a message indicating loss of game (registration-denied message) by default is displayed in step S406.

FIG. 16B is a flow chart showing the sorting and ranking process performed by the server 2 after the deadline. First, in step S501, the competition records saved in step S405 are sorted in order of dug depths. If the dug depth is the same, the competition records are sorted in descending order of scores.

Furthermore, in step S502, awards are given according to the rank determined by the sorting. The awards in this embodiment refer to money having value only between the service provider and players (a kind of service points). The acquired awards amounting to a predetermined value can be exchanged with a data of screen savers or melodies signaling an incoming call, etc. used for mobile phone 3.

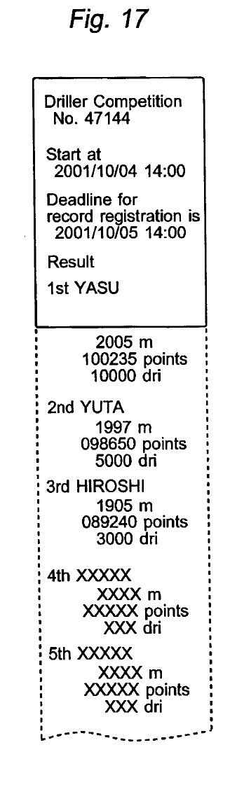

The ranking determined by the sorting is notified to each player by e-mail in step S503. For example, e-mail as shown in FIG. 17 showing the dug depth, score and acquired award (unit: dri) of each player will be sent to each player. It is also possible to announce it on a specific site so that players can access the site and see the ranking, instead of sending e-mails.

According to this embodiment, when result registrations by all players are completed before the deadline, the sorting and ranking process shown in FIG. 16B starts even before the deadline. Since members of each group are associated with their competition ID and stored in the hard disk 11, the server 2 can decide whether there are any remaining players who have not registered their results.

Finally, the method of deciding the level of a player in step S201 of FIG. 10 will be explained in detail. In the above service, if the level of a player is misjudged, classifying of the players is not performed appropriately and the object of the service is not fully achieved. For this reason, this embodiment is designed to decide the level of a player based on the actual play result of the player with particular attention to preventing cases caused by haphazard self-assessment where advanced players participate in a competition among beginners or beginners participate in a competition among advanced players. More specifically, the server 2 stores the best records registered by the players on the Best-Record-Registration screen 48 and competition records registered on the Competition-Record-Registration screen 51 for each player. Then, the server 2 calculates an average value of dug depths, and divides the average value by 100 and drops the fractional portion of the value. The server 2 designates the value after dropping fractional portion as the level of the player. For example, in the case of a player whose average depth of drilling is 1000 m, the level is 10. Using information of the stored play results as a basis for level assessment allows more accurate level assessment as the number of plays increases.

It goes without saying that it is also possible to decide the level based on best records alone or an average value of competition records alone. Furthermore, when the server 2 does not have information to decide the level of the player, classifying may be conducted assuming that the level of the player is the lowest level.

In addition, there can also be a mode in which the level of a player is decided based on information entered by the player at the time of an entry. For example, in the above embodiment, the Best-Record-Registration-Password entered on the Best-Record-Registration screen 48 may also be entered on the Competition-Entry screen 50. This mode is preferable because it eliminates the need for the server 2 to store the information of players' levels and allows the service provider to reduce the cost.

Furthermore, this embodiment is designed to allow players to register their best records on the Best-Record-Registration screen 48, but this embodiment may also be designed to allow players to register the average record or worst record. That is, the players may be allowed to register any records if these constitute grounds for deciding the levels of the players, not limited to the best record.

This service is different from conventional Internet Ranking services in that classifying of players is performed according to the levels of players, which allows all players to get his/her name listed in the ranking list. Particularly as in the case of this embodiment, if the levels of players are decided based on normal play results of those players, it is possible to exclude illegal level assessments and allow appropriate grouping. This allows beginners who have been originally extraneous to rankings to acquire awards and enjoy special incentives such as screen saver data by participating in a competition among only beginners. It also allows advanced players to compete with players of the same level and always enjoy a challenging competition. That is, all players can enjoy merits of the ranking service irrespective of their levels.

Here, even if rivals are of the same level, a game too easy or too difficult may reduce enjoyment of the competition by half. Therefore, the server 2 sets game tasks such as characters to be used or layout of the virtual space group by group. The players to be assigned tasks of an appropriate degree of difficulty according to the levels of the players can enjoy the game efficiently. Especially since the server of this embodiment gives advantages to players of relatively low levels in a group, players can compete with one another on an equal footing irrespective of level differences and enjoy a more fevered competition.

These effects are equally applicable not only to the case of this embodiment where a Competition-Play-Password is manually handed over to the game machine by the user, but also to a case where control data is directly transferred from the server 2 to a game machine equipped with a communication function.

When the information about the game tasks set by the server 2 is encoded and then handed over to a game machine as a Competition-Play-Password, the player can use the ranking decision service even if the game machine owned by the player is not provided with a communication function. That is, the service can be spread widely without limiting players' machine specification. It is also preferable because in this way illegal tampering with tasks by players can be prevented.

It goes without saying that the service provided by the above described server is not limited to a type of game which controls characters in the virtual space but applicable to all types of game. In this case, tasks to be set can be determined according to the type of game. For example, in the case of a racing game which controls movement of a racing car, the type of the racing car and course map may be designated as game tasks to be set. Furthermore, in the case of a match game such as a tennis game or martial arts game, it is possible to define a computer-controlled adversary for each level, assign the adversary according to the level of each player and let them match against each other. Furthermore, the present invention is not limited to a so-called video game accompanied by screen image, but it is also applicable to a boxing game competing for punching power of each player and other games. That is, a ranking decision service by the server of the present invention can be provided for any game in which various types of task can be set and play results are expressed as comparable numerical values irrespective of whether it is for the home game machines or for the arcade game machines.

According to the server and program product of the present invention, players are classified into groups according to the levels of the players beforehand at the time of deciding ranking, and all players from advanced players to beginners are given a chance to get his/her name listed in the ranking list.

Furthermore, the present invention sets tasks that influence the degree of difficulty of the game for each group, and can thereby allow all players to enjoy a match play with one another with tasks that suits their own levels.

It is further understood that the foregoing description is a preferred embodiment of the disclosed system and that various changes and modifications may be made in the invention without departing from the spirit and scope thereof.

The entire disclosure of a Japanese Patent Application No.2001-342749, filed on Nov. 8, 2001 including specification, claims drawings and summary, on which the Convention priority of the present application is based, are incorporated herein by reference in its entirety.

What is claimed is:

1. A computer system for providing a ranking service to players of a computer-controlled game, the system comprising:
means for receiving an entry data indicating an entry of a player to the ranking service from the player;
means for deciding a level of the player whose entry has been accepted by the receiving means;
means for classifying the players whose entries have been accepted into one or more groups based on players' levels respectively decided by the level deciding means;
means for assigning tasks to players in each group to which one or more players are assigned by the classifying means;
means for generating control data for each player that indicates the group to which the player belongs and the game task assigned to the player, the control data being used by the computer to control the game;
means for collecting result data indicating play results of the games that is controlled by using the control data generated by the data generating means; and
means for deciding ranking based on the play results collected by the result collecting means, for the each group to which one or more players are assigned by the classifying means respectively.

2. The system according to claim 1, further comprising means for providing the control data generated by the data generating means as a code generated by encoding the control data based on a predetermined rule, the code being composed of characters, numerals, symbols or a combination thereof.

3. The system according to claim 1, further comprising means for setting a dummy player so that the number of players belonging to one group becomes equal to or greater than a predetermined number, when the number of players assigned to the group by the classifying means is less than the predetermined number.

4. The system according to claim 1, wherein the task assigning means assigns different game tasks to each player in the same group.

5. The system according to claim 1, wherein the game is a type of game in which the player controls a character moving in a virtual space, and the task assigning means assigns the character to control as one of the tasks.

6. The system according to claim 1, wherein the game is a type of game in which the player controls movement of an object placed in a virtual space, and the task assigning means assigns a layout of the virtual space as one of the tasks.

7. The system according to claim 1, further comprising means for storing play results of the players, wherein the level deciding means decides the level of the player whose entry has been accepted based on the play results of the player stored by the storing means.

8. The system according to claim 1, wherein
the entry receiving means requests the player to input information about the level of the player when the entry is accepted; and
the level deciding means decides the level of the player based on the information about the level obtained by the entry receiving means.

9. The system according to claim 1, wherein the entry receiving means defines predetermined time intervals and accepts entries during the time intervals.

10. The system according to claim 1, wherein the entry receiving means defines a predetermined number of players and accepts entries on a first-come-first-served basis until the number of players whose entries have been accepted reaches the predetermined number.

11. A computerized method for providing a ranking service to players of a computer-controlled game, comprising:
(a) receiving an entry data indicating an entry of a player to the ranking service from the player;
(b) deciding a level of the player whose entry has been accepted in the entry receiving step;
(c) classifying the players whose entries have been accepted into one or more groups based on players' levels respectively decided in the level deciding step;
(d) assigning tasks to players in each group to which one or more players are assigned in the classifying step;
(e) generating control data for each player that indicates the group to which the player belongs and the game task assigned to the player, the control data being used by the computer to control the game;
(f) collecting result data indicating play results of the games that is controlled by using the control data generated in the data generating step; and
(g) deciding ranking based on the play results collected in the result collecting step, for the each group to which one or more players are assigned in the classifying step respectively.

12. The method according to claim 11, further comprising:
(h) providing the control data generated in the data generating step as a code generated by encoding the control data based on a predetermined rule, the code being composed of characters, numerals, symbols or a combination thereof.

13. The method according to claim 11, further comprising:
(i) setting a dummy player so that the number of players belonging to one group becomes equal to or greater than a predetermined number, when the number of players assigned to the group in the classifying step is less than the predetermined number.

14. The method according to claim 11, wherein the task assigning step comprises assigning step of different game tasks to each player in the same group.

15. The method according to claim 11, wherein the game is a type of game in which the player controls a character moving in a virtual space, and
the task assigning step comprises a step for assigning the character to control as one of the tasks.

16. The method according to claim 11, wherein the game is a type of game in which the player controls movement of an object placed in a virtual space, and
the task assigning step comprises a step for assigning a layout of the virtual space as one of the tasks.

17. The method according to claim 11, wherein the level deciding step comprises deciding step of the level of the player whose entry has been accepted based on the play results of the player stored in a storage medium.

18. The method according to claim 11, wherein
the entry receiving step comprises requesting the player for inputting information about the level of the player when the entry is accepted; and
the level deciding step comprises deciding the level of the player based on the information about the level obtained in the entry receiving step.

19. The method according to claim 11, wherein the entry receiving step comprises defining predetermined time intervals and accepts entries during the time intervals.

20. The method according to claim 11, wherein the entry receiving step comprises defining a predetermined number of players and accepting entries on a first-come-first-served basis until the number of players whose entries have been accepted reaches the predetermined number.

21. A computer-readable medium on which is stored program modules comprising instructions for providing a ranking service to players of a computer-controlled game which, when executed by a computer, cause the computer to perform the steps of:
(a) receiving an entry data indicating an entry of a player to the ranking service from the player;
(b) deciding a level of the player whose entry has been accepted in the entry receiving step;
(c) classifying the players whose entries have been accepted into one or more groups based on players' levels respectively decided in the level deciding step;
(d) assigning tasks to players in each group to which one or more players are assigned in the classifying step;
(e) generating control data for each player that indicates the group to which the player belongs and the game task assigned to the player, the control data being used by the computer to control the game;
(f) collecting result data indicating play results of the games that is controlled by using the control data generated in the data generating step; and
(g) deciding ranking based on the play results collected in the result collecting step, for the each group to which one or more players are assigned in the classifying step respectively.

22. The computer-readable medium according to claim 21, the instruction further causing the computer to perform the step of
(h) providing the control data generated in the data generating step as a code generated by encoding the control data based on a predetermined rule, the code being composed of characters, numerals, symbols or a combination thereof.

23. The computer-readable medium according to claim 21, the instruction further causing the computer to perform the step of
(i) setting a dummy player so that the number of players belonging to one group becomes equal to or greater than a predetermined number, when the number of players assigned to the group in the classifying step is less than the predetermined number.

24. A computer data signal embodied in a carrier wave and representing sequences of instructions for providing a ranking service to players of a computer-controlled game which, when executed by a computer, cause the computer to perform the steps of:
(a) receiving an entry data indicating an entry of a player to the ranking service from the player;
(b) deciding a level of the player whose entry has been accepted in the entry receiving step;
(c) classifying the players whose entries have been accepted into one or more groups based on players' levels respectively decided in the level deciding step;
(d) assigning tasks to players in each group to which one or more players are assigned in the classifying step;
(e) generating control data for each player that indicates the group to which the player belongs and the game task assigned to the player, the control data being used by the computer to control the game;
(f) collecting result data indicating play results of the games that is controlled by using the control data generated in the data generating step; and
(g) deciding ranking based on the play results collected in the result collecting step, for the each group to which one or more players are assigned in the classifying step respectively.

25. The computer data signal according to claim 24, the instruction further causing the computer to perform the step of
(h) providing the control data generated in the data generating step as a code generated by encoding the control data based on a predetermined rule, the code being composed of characters, numerals, symbols or a combination thereof.

26. The computer data signal according to claim 24, the instruction further causing the computer to perform the step of
(i) setting a dummy player so that the number of players belonging to one group becomes equal to or greater than a predetermined number, when the number of players assigned to the group in the classifying step is less than the predetermined number.
